(19) United States
(12) Patent Application Publication
(10) Pub. No.: US 2007/0081324 A1
(43) Pub. Date: Apr. 12, 2007

(54) LED ILLUMINATED LAYNARD

(75) Inventors: Michael L. Schrimmer, Vernon Hills, IL (US); Ronald E. Gilley, Winnetka, IL (US)

Correspondence Address: LEVENFELD PEARLSTEIN;Intellectual Property Department, 2 North LaSalle, Suite 1300, CHICAGO, IL, 60602, US

(73) Assignee: CHEMICAL LIGHT, INC., Vernon Hills, IL (US)

(21) Appl. No.: 11/163,266

(22) Filed: Oct. 12, 2005

(51) Int. Cl. F21V 21/08

(52) U.S. Cl. 362/103

(57) ABSTRACT

An illuminated lanyard includes a plurality of light emitting diodes, a plurality of conductors having the light emitting diodes mounted to the conductors spaced from one another along the length of the conductors. The light emitting diodes and the conductors define an LED assembly. A power source is operably connected to the LED assembly and a switch operably connects the power source to the LED assembly. A housing houses the power source and the switch. A light transmissive sheath is configured having the LED assembly fitted, at least in part, in the sheath. A translucent sleeve is positioned over the sheath and encloses the LED assembly. The sheath and sleeve are mounted to the housing. The light emitting diodes are illuminated by actuation of the switch, and light from the light emitting diodes is transmitted by the diodes and is visible through the sheath and through the translucent sleeve. The lanyard can be configured for securing a pair of glasses thereto.

### BACKGROUND OF THE INVENTION

The present invention is directed to a novelty device. More specifically, the present invention is directed to a LED illuminated lanyard novelty device.

Novelty devices come in all manner, shape and size. Illuminated devices are typically more interesting and attraction-grabbing in that one's eyes are, by instinct, drawn to a lighted object. This is even more so when the lights (illumination) is colored and/or on and off in, for example, a blinking fashion.

Lanyards have recently become popular with young people as a means to carry certain items, in the entertainment industry as a novelty device and for carrying, for example entrance passes, in the workplace to carry/display identification and access cards and in the convention industry to carry/display identification and access cards.

Lanyards have also become popular as advertising and marketing tools. Many companies have come to apply logos, company names and brand names to lanyards that are given away at meetings, conventions, in stores and the like. For example, at many large conventions, different companies' representatives may be vying with one another to have attendees wear their lanyards.

At present, the differences between one lanyard and the next is the color and/or size. No other characteristics provide a distinction between available lanyards.

Accordingly, there is a need for a high visual quality lanyard device. Desirably, such a lanyard is readily distinguished from other lanyards by a characteristics other than color or size. Most desirably, such a lanyard is manufactured in a cost effective manner such that larger quantities are not cost prohibitive.

### BRIEF SUMMARY OF THE INVENTION

An LED illuminated lanyard includes a plurality of light emitting diodes and aa plurality of conductors having the light emitting diodes mounted to the conductors spaced from one another along the length of the conductors. The light emitting diodes and the conductors define an LED assembly.

A power source is operably connected to the LED assembly and a switch is operably connects the power source to the LED assembly. A housing houses the power source and the switch.

The LED assembly is fitted into a light transmissive sheath. The sheath has a first end connected to the housing and a second free end. A translucent sleeve is positioned over the sheath and encloses the LED assembly. First and second ends of the sleeve are connected to the housing.

The light emitting diodes are illuminated by actuation of the switch and light from the light emitting diodes is transmitted by the diodes and is visible through the sheath and through the translucent sleeve.

In a present embodiment, the sleeve is formed from a woven material. The lanyard includes circuitry, carried on a circuit board, for illuminating the light emitting diodes at certain predetermined times and intervals. The light emitting diodes can be illuminated in flashing scheme or in a continuous “on” or lighted scheme.

A clip can be disposed on the lanyard at an end opposite of the housing, and a ring can be disposed on the lanyard between the clip and the housing. The ring can be movable (e.g., slide) along the lanyard between the clip and the housing.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an LED illuminated lanyard embodying the principles of the present invention;

FIG. 2 is a perspective view similar to FIG. 1, showing the LED assembly components of the lanyard in phantom lines;

FIG. 3 is perspective view similar to FIG. 1, showing the LED assembly components in an exploded perspective;

FIG. 4 is an exploded view of the lanyard housing;

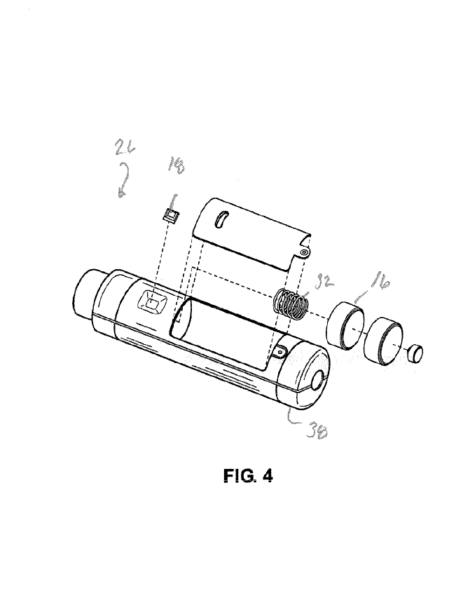

FIG. 5 is an exemplary braided outer sheath section; and

FIG. 6 is a perspective view of an alternate embodiment illustrating a glasses securing embodiment of the lanyard.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

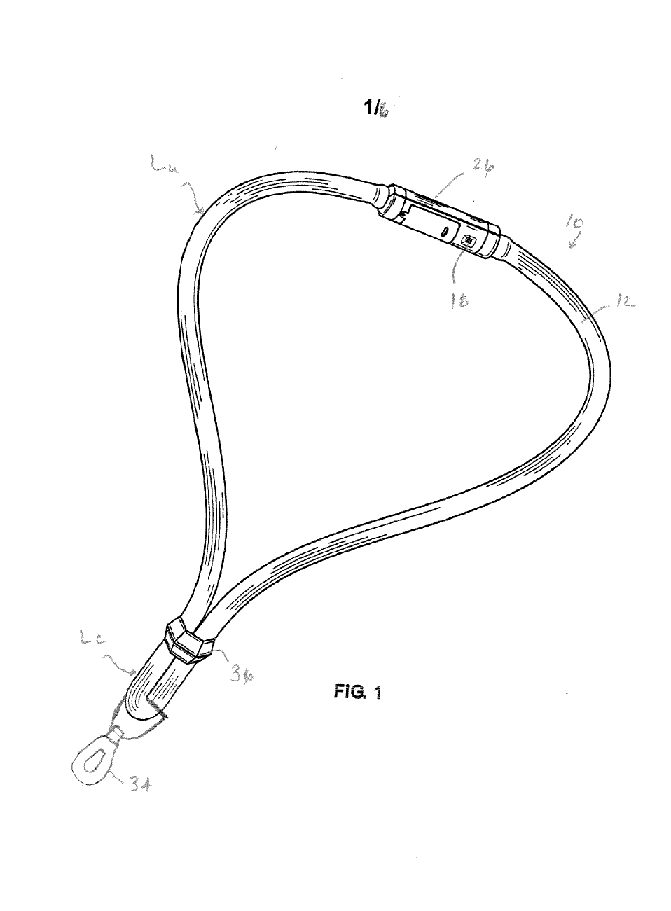

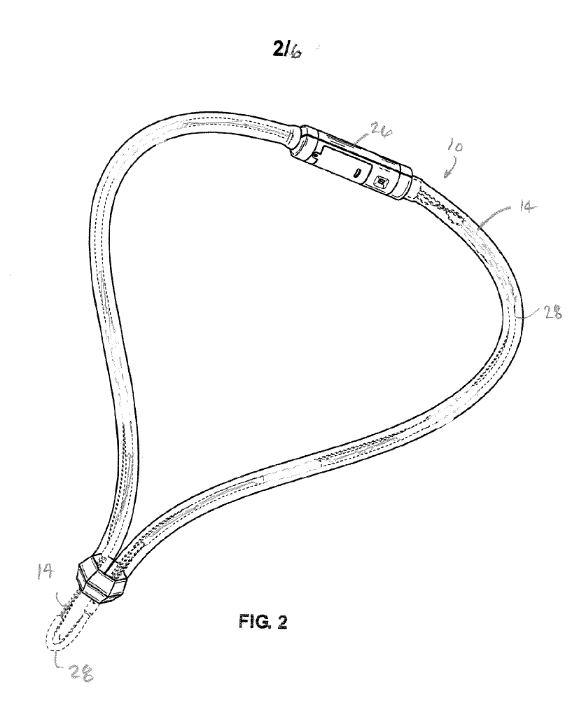

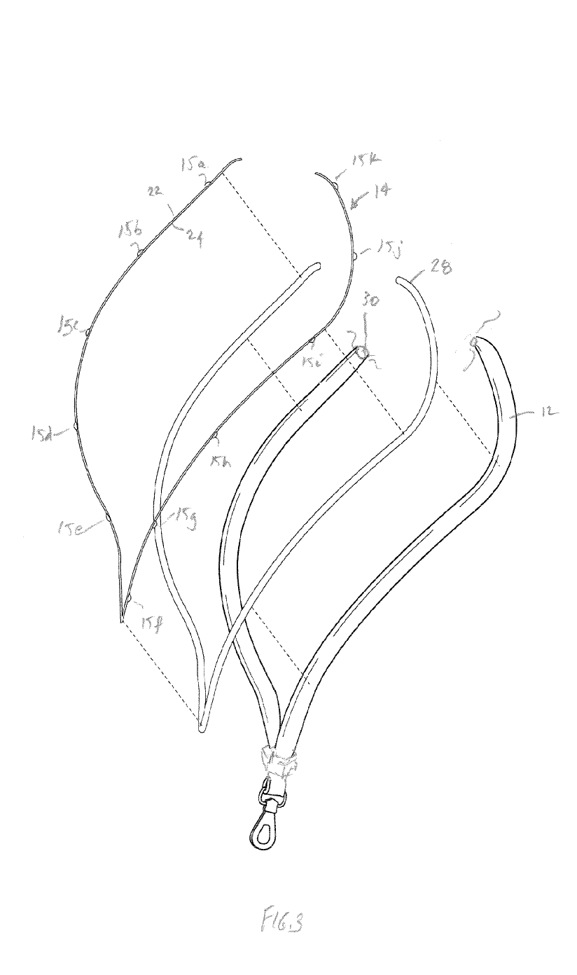

Referring now to the figures, and in particular to FIGS. 1-3, there is shown an LED (light emitting diode) illuminated lanyard 10 in accordance with the principles of the present invention. The lanyard 10 includes an outer woven covering 12, an LED assembly 14, a power source 16, a switch 18, and a circuit board 20 for control of the LED assembly 14.

The LED assembly 14 is an elongated element having multiple LEDs 15a-k (collectively, 15) connected to one another both electrically and physically by conductors 22, 24. The power source 16 and switch 18 are mounted in a housing 26 (that also functions to complete the lanyard loop L). The circuit board 22 is disposed in the housing 26.

The LED assembly 14 can be disposed in an optional carrier, such as a section of an elongated translucent tube or sheath 28. In a present embodiment the tube 28 is transparent, formed from a material such as TYGON® or like flexible, resilient and strong transparent material; however, it will be appreciated that the tube 28 can be translucent and/or ornamented or the like. The tube 28 is configured so that the LED assembly 14 is fitted within the tube 28 and is protected as it resides within the tube 28. it will be appreciated that the LED assembly 14 need not be placed in sheath or other carrier.

Those skilled in the art will recognize that there are a relatively large number of types of LEDs currently available. The present lanyard 10 uses a plurality of miniature or subminiature LEDs 15 so that the sheath 28 can remain a relatively small diameter tube 28 (about ⅛- 3/16 inch outside diameter).

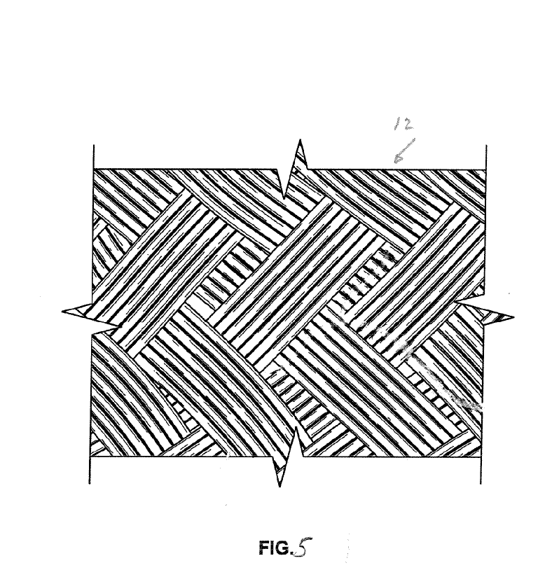

The outer woven covering 12 is formed in much the same manner as a lace. That is, a textile material (natural or synthetic) is braided or interwoven (see FIG. 5) to form an open, woven sleeve-like element with an open central region 30. It will be appreciated that the covering 12 can be printed or the like with a name or logo when, for example, the lanyard is used as a promotional device. The LED assembly 14 is positioned in the sheath 28 which is positioned in the open central region 30 such that the lanyard 10 appears as a conventional (non-illuminated) device. Because the LEDs 15 are housed in a relatively small diameter tube 28 this has the advantage of permitting the lanyard 10 to be of a conventional size; that is the lanyard 10 can have a flat lace width of about ½ inch, and thus the lanyard 10 appears as a conventional lanyard.

As set forth above, the housing 26 houses the switch 18 and the power source(s) 16. In a present embodiment, batteries 16 are carried by the housing 26 in a biased (spring 32 held) arrangement. The spring 32 arrangement holds the batteries 16 in the housing 26 in a substantially secure manner while at the same permitting ready access to the batteries 16 for replacement.

To facilitate manufacture and assembly, the LED assembly 14 is constructed so that the conductors 22, 24 and the LEDs 15 are provided fabricated as a linear assembly in a flexible or bendable manner. The LED assembly 14 is inserted into an end of the sheath 28 and the sheath 28 is inserted into the sleeve 12. A clip or other securing device 34 is positioned on the lanyard 10 and a band or other ring-like element 36 can be fitted onto the lanyard 10 to maintain the upper looped portion LU and the lower clip 34-provided portion LC. The band 36 is an optional element, and need not be used with the lanyard 10. The band 36, if used, can be fixed along the lanyard 10 or can be movable along the lanyard 10. A connector 38 is fitted onto a free end of the sheath 28 and cover 12 and the assembly (including the LED assembly 14, the sheath 28 and the cover 12) can then be connected and wired to the housing 26. The connector 38 can be separated from the housing 26 to facilitate wearing the lanyard 10.

In a present lanyard 10, the assembly 14 includes eleven LEDs 15, which can be the same or different colors. The assembly 12 is configured (by the electronics on the circuit board 20) to provide a number of different lighting schemes. For example, the assembly 14 is configured to provide a fast and/or slow flashing scheme and an “on” or lighted scheme. Other lighting schemes can include one-direction sequential flashing scheme (lights appearing to move around in a circle) and a two-direction sequential flashing scheme (lights appear to move one way and then “bounce” back the opposite way).

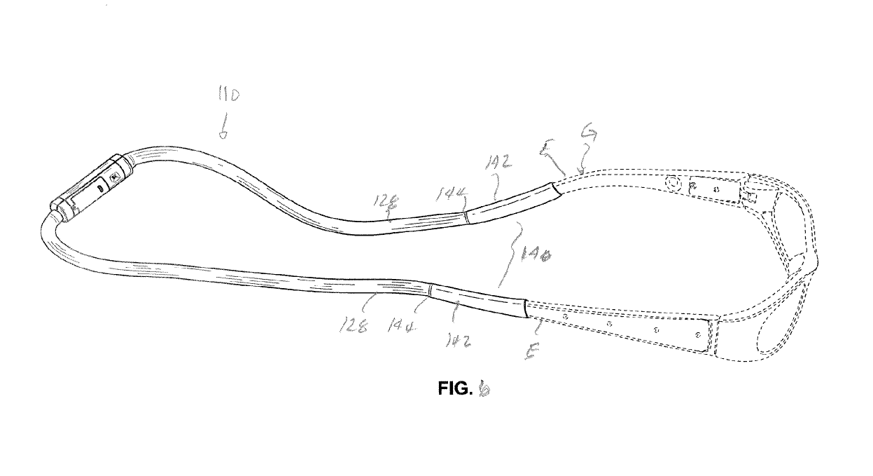

An alternate embodiment of the lanyard 110 is illustrated in FIG. 6. In this embodiment, the lanyard 110 serves as an eyeglasses (sunglasses and the like) holder to secure a pair of eyeglasses G on a wearer's neck. The lanyard 110 includes an opening or separation 140 at about the mid-point. A pair of resilient or elastic end sleeves 142 are affixed to the ends 144 of the separated sections. The resilient sleeves 142 are configured to receive the earpieces E from the glasses G. In this manner, the glasses G are secured, at the earpieces E, to the lanyard 110 by the resilient sleeves 142. The sleeves 142 can be fitted within the sheath 128 so that it appears that the sheath 128 is fitted over the earpieces E.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the disclosed, exemplary embodiment.

What is claimed is:

1. An illuminated lanyard device comprising:
a plurality of light emitting diodes;
a plurality of conductors, the light emitting diodes mounted to the conductors spaced from one another along the length of the conductors, the light emitting diodes and the conductors defining an LED assembly;
a power source operably connected to the LED assembly;
a switch operably connecting the power source to the LED assembly;
a housing for housing the power source and the switch;
a light transmissive sheath, the LED assembly fitted, at least in part, in the sheath, the sheath having a first end connected to the housing and a second free end; and
a translucent sleeve positioned over the sheath and enclosing the LED assembly, first and second ends of the sleeve being connected to the housing,
wherein the light emitting diodes are illuminated by actuation of the switch, and wherein light from the light emitting diodes is transmitted by the diodes and is visible through the sheath and through the translucent sleeve.

2. The illuminated lanyard device in accordance with claim 1 wherein the sleeve is formed from a woven material.

3. The illuminated lanyard device in accordance with claim 1 including circuitry for illuminating the light emitting diodes at certain predetermined times and intervals.

4. The illuminated lanyard device in accordance with claim 3 wherein the circuitry is carried on a circuit board.

5. The illuminated lanyard device in accordance with claim 3 wherein the light emitting diodes are illuminated in flashing scheme.

6. The illuminated lanyard device in accordance with claim 3 wherein the light emitting diodes are illuminated in a continuous on lighting scheme.

7. The illuminated lanyard device in accordance with claim 1 including a clip disposed on the lanyard at an end opposite of the housing.

8. The illuminated lanyard device in accordance with claim 7 including a ring disposed on the lanyard between the clip and the housing.

9. The illuminated lanyard device in accordance with claim 8 wherein the ring is movable along the lanyard between the clip and the housing.

10. The illuminated lanyard device in accordance with claim 1 including a separation at about a midpoint of the sheath, the LED assembly and the translucent sleeve positioned, the separation defining a pair of ends in the sheath, the LED assembly and the translucent sleeve, and including a resilient sleeve mounted to each of the sheath, LED assembly and translucent sleeve ends, the resilient sleeves configured to receive an earpiece from a pair of eyeglasses.

11. An illuminated lanyard device comprising:
a plurality of light emitting diodes;
a plurality of conductors, the light emitting diodes mounted to the conductors spaced from one another along the length of the conductors, the light emitting diodes and the conductors defining an LED assembly;
a power source operably connected to the LED assembly;
a switch operably connecting the power source to the LED assembly;
circuitry for illuminating the light emitting diodes at certain predetermined times and intervals;
a housing for housing the power source, the switch and the circuitry;
a light transmissive sheath, the LED assembly fitted, at least in part, in the sheath, the sheath having a first end connected to the housing and a second free end; and
a translucent sleeve positioned over the sheath and enclosing the LED assembly, the sleeve being formed from a woven material, first and second ends of the sleeve being connected to the housing;
a clip disposed on the lanyard at an end opposite of the housing; and
a ring disposed on the lanyard between the clip and the housing,
wherein the light emitting diodes are illuminated by actuation of the switch, and wherein light from the light emitting diodes is transmitted by the diodes and is visible through the sheath and through the translucent sleeve.

12. The illuminated lanyard device in accordance with claim 11 wherein the ring is movable along the lanyard between the clip and the housing.

13. The illuminated lanyard device in accordance with claim 11 wherein the light emitting diodes are illuminated in a flashing scheme.

14. The illuminated lanyard device in accordance with claim 11 wherein the light emitting diodes are illuminated in a continuous on lighting scheme.
